(19) United States
(12) Patent Application Publication
(10) Pub. No.: US 2016/0044907 A1
(43) Pub. Date: Feb. 18, 2016

(54) Animal Overshoes

(71) Applicant: Nigel Alexander Buchanan, New Gilston by Leven (GB)

(72) Inventor: Nigel Alexander Buchanan, New Gilston by Leven (GB)

(21) Appl. No.: 14/461,873

(22) Filed: Aug. 18, 2014

(51) Int. Cl. A01L 3/04

(52) U.S. Cl. CPC A01L 3/04

(57) ABSTRACT

An animal overshoe has a base plate and a plurality of elongate members connected to the base plate. The elongate members are each provided with a formation configured to enable securing of the overshoe to a foot of an animal by an elongate securing member engaging the formations with the elongate members in an upstanding condition with respect to the base plate.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### CROSS-REFERENCES TO RELATED APPLICATIONS

This application claims benefit of the following patent application(s) which is/are hereby incorporated by reference: None

### STATEMENT REGARDING FEDERALLY SPONSORED RESEARCH OR DEVELOPMENT

Not Applicable

### REFERENCE TO SEQUENCE LISTING OR COMPUTER PROGRAM LISTING APPENDIX

Not Applicable

### BACKGROUND OF THE INVENTION

The present invention relates generally to animal overshoes that may be used to protect injuries, infections or bandages and particularly, but not exclusively, to overshoes for horses.

What is needed, then, is a way to protect an injured, infected or bandaged foot from moisture, dirt or further injury.

When animals suffer injuries or infection to their feet, the ailment can be exacerbated by the everyday ingress of dirt or debris. Without a suitable means for protecting against damage, moisture or dirt, any applied poultice or bandage is of little use.

Animals with bandaged feet cannot always be kept inside and homemade covers made from plastic bags and duct tape or the like offer little wear protection if the animal uses the foot at all. Also, the ailment cannot “breathe”, which sometimes causes more of a problem than the original ailment.

There exist many types of horse boots that are not unlike a ski boots. These boots are normally excellent, but are very expensive. They are also impossible to clean if the hoof has a contagious infection and as a consequence are not reusable.

Known covers may comprise a sole portion and various types of sticky flaps that stick to each other and the hoof to form a boot-like shape in order to protect the hoof or any bandage upon the hoof prior to the fitting of the cover.

### BRIEF SUMMARY OF THE INVENTION

The invention provides an animal overshoe comprising:

a base plate; and

a plurality of elongate members connected to said base plate,

wherein said elongate members each comprise a formation configured to enable securing of the overshoe to a foot of an animal by an elongate securing member engaging said formations with at least a portion of each said elongate member in an upstanding condition with respect to said base plate.

The invention also includes an animal overshoe comprising:

a base plate; and

a plurality of elongate members hinge connected to an outer periphery of said base plate by respective first hinges to permit movement of said elongate members to an upstanding condition with respect to said base plate,

wherein said elongate members each comprise a plurality of segments that are connected to adjacent segments of the elongate member by respective second hinges to permit each segment to be moved to an upstanding position with respect to said base plate independently of movement permitted by said first hinges,

wherein said elongate members each comprise a formation configured to enable securing of the overshoe to a foot of an animal by an elongate securing member engaging said formations with at least a portion of each said elongate member in said upstanding condition with respect to said base plate, and

wherein said outer periphery comprises a front end portion having an arched profile and a rear end portion extending transverse to said arched profile and extending between respective ends of said arched profile, the elongate members connected to said front end portion have a first width and there is one elongate member attached to said rear end portion that has a width greater than said first width.

The invention also includes a method of providing an overshoe on an animal's foot, said method comprising:

applying a base plate of an overshoe to a body representative of the said of the animal's foot and bending a plurality of elongate members that project from an outer periphery of said base plate to bring at least a portion of each said elongate member into an upstanding condition so that said upstanding elongate members partially surround said outer periphery leaving an opening at said outer periphery;

separating said overshoe from said body;

inserting said animal's foot through said opening to position an underside of said foot on said base plate with said upstanding elongate members partially surrounding said foot,

bending further elongate members that project from said outer periphery to bring at least a portion of each of said further elongate members into an upstanding condition to close said opening; and

securing said overshoe to said foot by fitting an elongate securing member to respective formations provided on said elongate members.

Examples of the invention include a hoof overshoe that comprises a generally flat central base plate having a plurality of fingers and a rear folding portion disposed about its periphery. The fingers and rear folding portion are hinge connected to the base plate and incorporate retention loops through which various types of belts, cords or straps including cable ties can be fitted. The fingers and rear folding portion may be divided into hinge connected segments. The use of the segmented fingers and a segmented rear folding portion allows several sizes of hoof or foot to be provided for by one basic shoe. When utilized on a horse's hoof, a previously used horseshoe may be used as a size reference and the overshoe prepared for fitting by pre-folding the fingers so that they are upstanding adjacent the outer periphery of the horseshoe. By threading an appropriate belt, cord, strap or cable tie through the appropriate retention loops on the already folded fingers, the hoof overshoe can take on the shape of a slipper, the back portion of which is still open. When ready, the animal's hoof is lifted and the “slipper” is slipped onto the front of the hoof. The rear folding portion can then be folded at an appropriate hinge and the belt, cord, strap or cable tie fitted through the rear folding portion retention loops. The belt, cord, strap or cable tie is then appropriately tightened and locked, or otherwise secured, to complete the fitting of the hoof overshoe. When the adjustable fingers are pre-shaped in this way, fitting to animal's foot can take less than thirty seconds, which is convenient for the user and reduces the stress caused to the animal. If an old horseshoe is not available, or fitting is taking place on an animal other than a horse, the base plate may be temporarily fitted to the animal's foot in order to ascertain the correct size of the sole prior to shaping the fingers.

When used as a protector after a bandage or poultice has been fitted to a diseased or damaged foot, an intermediate sock or the like may be used. The intermediate sock may be made from a moisture-proof material that is also air permeable. The incorporation of a pull cord or the like at the mouth of the intermediate sock facilitates retention of the sock until the hoof overshoe is correctly fitted. The hoof overshoe protects the intermediate sock from undue wear or damage and likewise the bandage or poultice is protected from the elements by the intermediate sock, which being air permeable allows the ailment to “breathe”.

The hoof overshoe may comprise a molded plastic base plate having hinge connected fingers and a hinged rear portion extending from its periphery. In one example the overshoe is injection-molded. The molding may be generally flat, which may result in an inexpensive mold tool and reduce transport and packaging costs.

The hoof overshoe may have fingers and a rear folding portion divided into hinge connected segments. The hinges may take the form of grooves, or indentations, extending across the fingers and rear folding portion. The grooves, or indentations, form a weakened part in the structure that allows bending along the length of the groove, or indentation, without detriment to the structure. When made of a plastics material, the material chosen for the manufacture of the overshoe fingers and rear folding portion may have a composition such as polypropylene which is suitably resilient. The hinge grooves, or indentations, preferably have a rounded profile in order to prevent stress cracking.

The illustrated example has fingers and a rear folding portion divided into three segments by two hinges disposed away from the connection to the base plate. However, it will be understood that this is not essential and that there may be two or more segments as desired. Furthermore, in some examples, the fingers and rear folding formation may have no hinge connected segments.

The illustrated hoof overshoe has fingers and a rear folding portion divided into segments by integral hinges. In other examples, the hinges may connect separate segment parts by means of swivel pins so that, for example, the fingers and rear folding portion can be molded separately of the base plate.

The hoof overshoe wherein both the adjustable fingers and the rear portions have hinges between the adjustable sections. The folding sections or joints have loops, hooks, catches or the like on the outside profile of the shoe for the useful attachment or gripping engagement in conjunction with a strap or band. When the overshoe is shaped and fitted to the applied foot, the strap, band, belt etc. preferably encompasses the appropriate top section or sections of the overshoe whereas the strap(s) is threaded and retained through the loops in the shaped fingers and rear portion, in order that when appropriately tightened and locked they form a method of retaining in a robust and secure manner the overshoe on the foot of the animal wearing it. Any surplus sections can be cut off if required, the hinge indentations usefully being used as cut lines.

The underside of the base plate of the hoof overshoe may be provided with a gripping profile(s) in order to improve the grip, or traction, provided by the overshoe. This is particularly useful if the overshoe is utilized as a temporary shoe. If a horse were to lose a shoe when fitting a normal replacement were not possible, a hoof overshoe could be fitted in order to provide hoof protection until such time as a normal replacement shoe could be fitted.

The base plate of the hoof overshoe may be provided with discontinuities such as through-hole or perforations. If a circumstance exists where a hoofed animal requires support within its hoof cavity, that is the sole upbulging, horn jets and radiation furrows upon the bottom surface of the hoof, a correspondingly shaped filler or wadding can be made by providing filler material on the top side of the base plate and pressing the base plate against the hoof. The filler material will engage the discontinuities under the pressure applied through the base plate to improve adhesion to the base plate. The filler material can be covered with a thin plastic sheet or the like, or the hoof bottom face coated with petroleum jelly, so that the filler material takes up the shape of the hoof cavity, but does not stick to the animal's hoof. The overshoe with the shaped filler can then be set aside until the filler is set to form a profiled insert. The provision of a profiled insert in this way allows the simple and inexpensive provision of custom made therapeutic protective footwear for hoofed animals.

The hoof overshoe may be provided with an elongate securing member in the form of a “cable tie”, strap or belt provided with a weakening formation. This make take the form of a reduced thickness section(s) at a point(s) along its length. The weakening formation provides a safety break point. If the animal were to catch any part of the hoof overshoe, or its retaining strap, on an object such as a boundary fence, the weakening formation(s) should fracture before the animal is injured by the hoof overshoe not releasing from the object.

Animal overshoes as illustrated and described in this specification may at least partially alleviate the disadvantages of the prior art devices described above, or at least provide an alternative to existing products. The animal overshoe may be easily made to fit quite a wide size range of animal feet and be low cost and simple to manufacture yet be quick to fit. If produced as a flat product, the packaging needed should be minimal. In most cases the animal overshoe will be reusable after appropriate cleaning and any plastics parts may be made of a fully recyclable plastics material.

### BRIEF DESCRIPTION OF THE SEVERAL VIEWS OF THE DRAWINGS

In order that the invention may be well understood, some examples thereof, which are given by way of example only, will now be described with reference to the drawings, in which:

FIG. 1 is a perspective view of an animal overshoe fitted to a horse's hoof;

FIG. 2 is a is a top plan view of the animal overshoe of FIG. 1;

FIG. 3 is a perspective bottom view of the animal overshoe of FIG. 1;

FIG. 4 is a is a perspective view of the animal overshoe of FIG. 1 in one folded, use, condition;

FIG. 5 is a perspective view of the animal overshoe of FIG. 1 in another folded, use, condition;

FIG. 6 is a view corresponding to FIG. 3 showing a profiled insert fitted to the animal overshoe; and

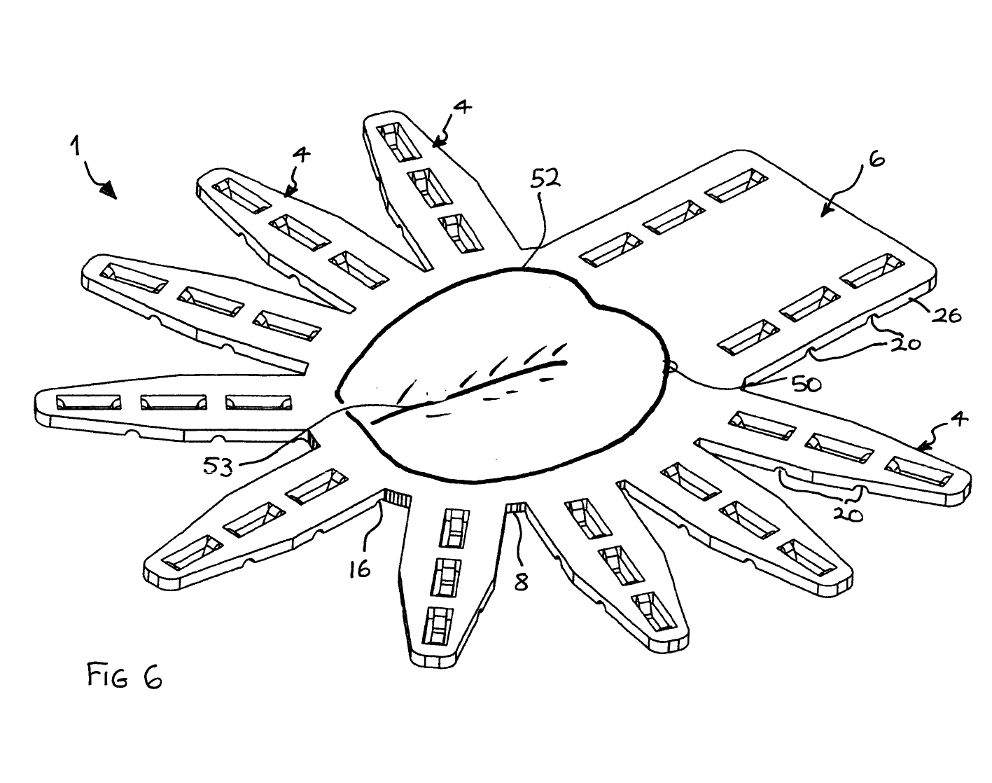

FIG. 7 is a perspective view of the animal overshoe secured to a horse's hoof by an alternative elongate securing member.

### DETAILED DESCRIPTION OF THE INVENTION

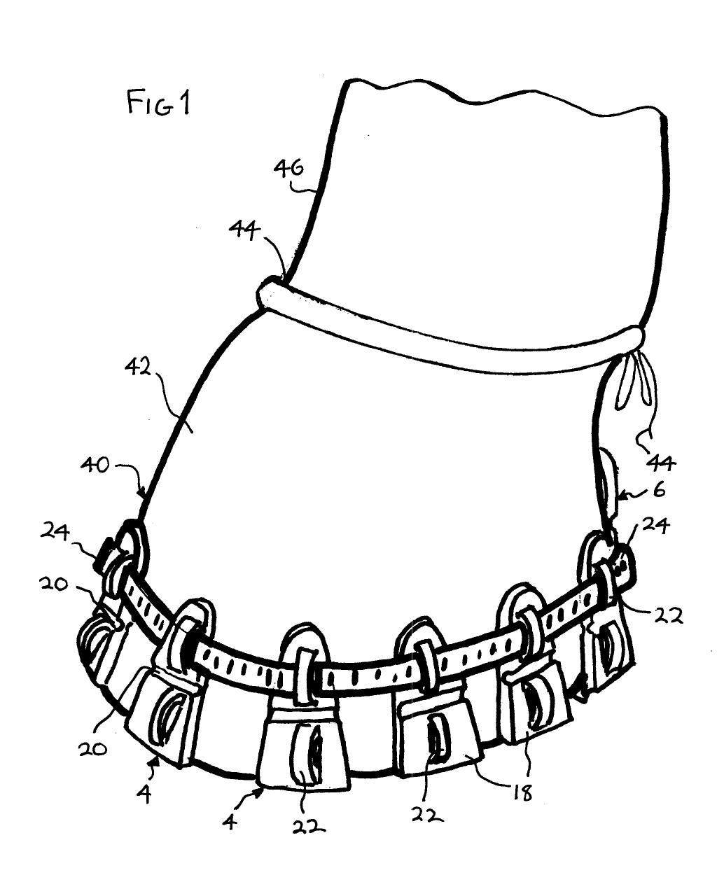

Referring to FIGS. 1 to 3, an animal overshoe 1 comprises a base plate 2 that has a plurality of elongate members 4, 6 disposed around its outer periphery 8. In the illustrated example, the outer periphery 8 has a front end portion with an arched profile and a rear end portion that connects the respective ends of the front end portion. The elongate members comprise a plurality of relatively narrow fingers 4 disposed around front end portion of the outer periphery 8 and a relatively wider rear folding portion 6 connected with the rear end portion of the outer periphery. The base plate 2 has a top surface 10 that in use faces the animal's foot and an underside 12. The underside 12 may be provided with a gripping profile(s) 14 to provide improved grip, or traction, when an animal wearing the overshoe is walking.

The fingers 4 are hinge connected to the outer periphery 8 of the base plate 2 by respective first hinges 16. Each finger 4 may be divided into segments 18 by one or more second hinges 20 disposed along the length of the finger and spaced from the hinge 16. In the illustrated example each finger 4 has two second hinges 20 disposed at spaced apart intervals along the length of the finger so that the finger is divided into three segments 18. At least one segment 18 of each finger 4 is provided with a formation 22 configured to be engaged by an elongate securing member 24 (FIG. 1) to enable the overshoe 1 to be secured to an animal's foot with the fingers 4 in an upstanding, or folded, condition.

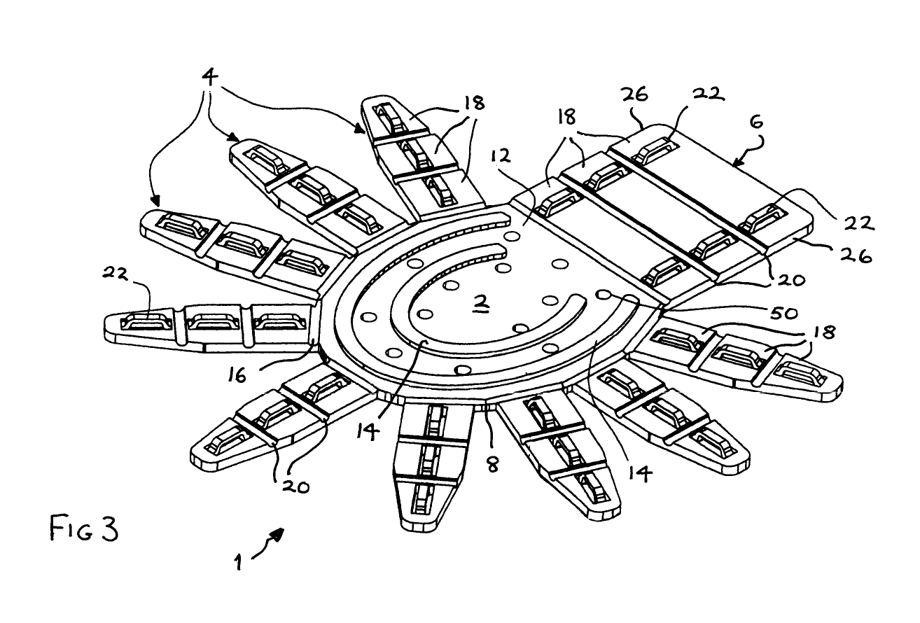

The rear folding portion 6 extends across the entire width of the rear portion of the outer periphery 8 of the base plate 2. The rear folding portion 6 is connected to the base plate 2 by a first hinge 16 and like the fingers 4, the rear folding portion is divided into three segments 18 by two second hinges 20. At least one segment 18 of the rear folding portion 6 is provided with at least one formation 22. As best seen in FIG. 3, in this example each segment 18 of the rear folding portion 6 has two formations 22, which are disposed in spaced apart relation so as to be adjacent respective sides 26 of the rear folding formation. In the illustrated example, the first and second hinges 16, 20 are provided as grooves, recesses or indentations extending across the finger 4 or rear folding portion 6 to provide a pliable reduced thickness section that allows hinge-like bending of the finger or the rear folding portion.

In the illustrated example the formations 22 are generally U-shaped projections that combine with the respective fingers 4 or rear folding portion 6 to define a loop through which an elongate securing member 24 can be threaded in the manner shown in FIG. 1. As described in more detail below, an elongate securing member 24 can be threaded through the loops to secure the animal overshoe to an animal's foot.

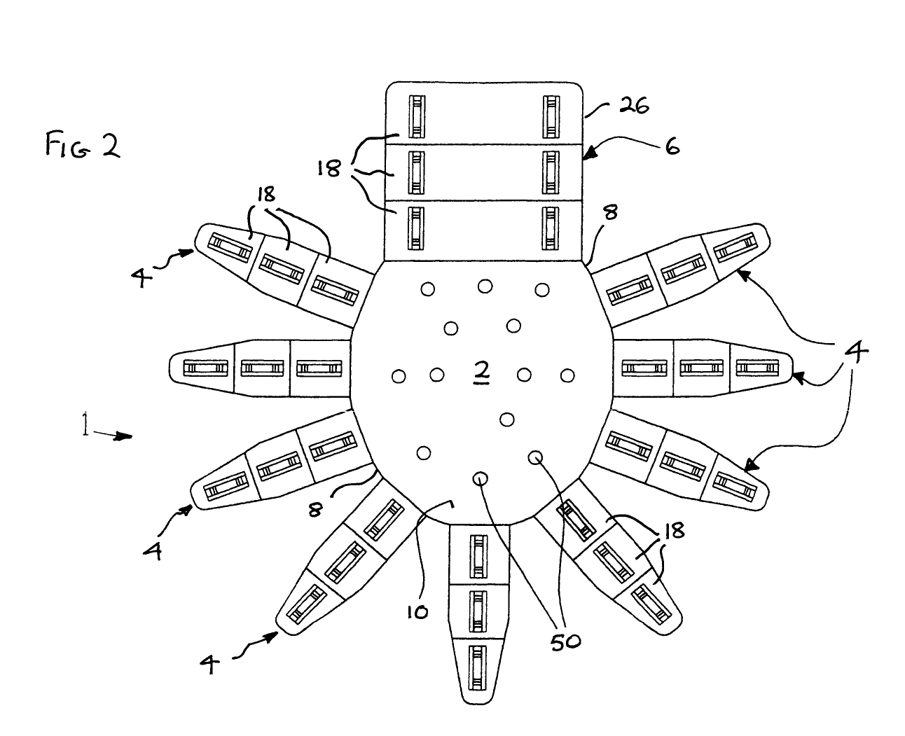

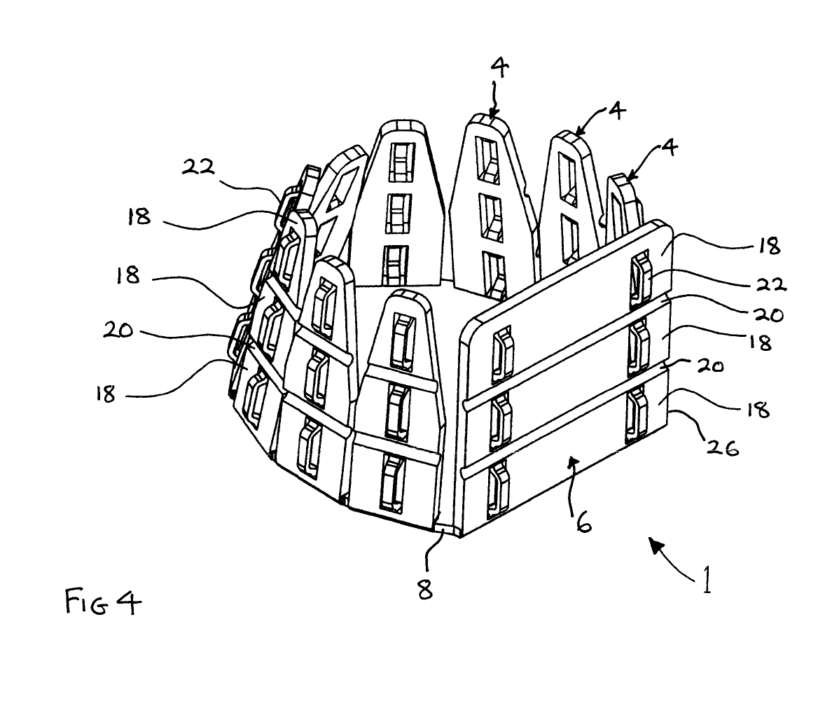

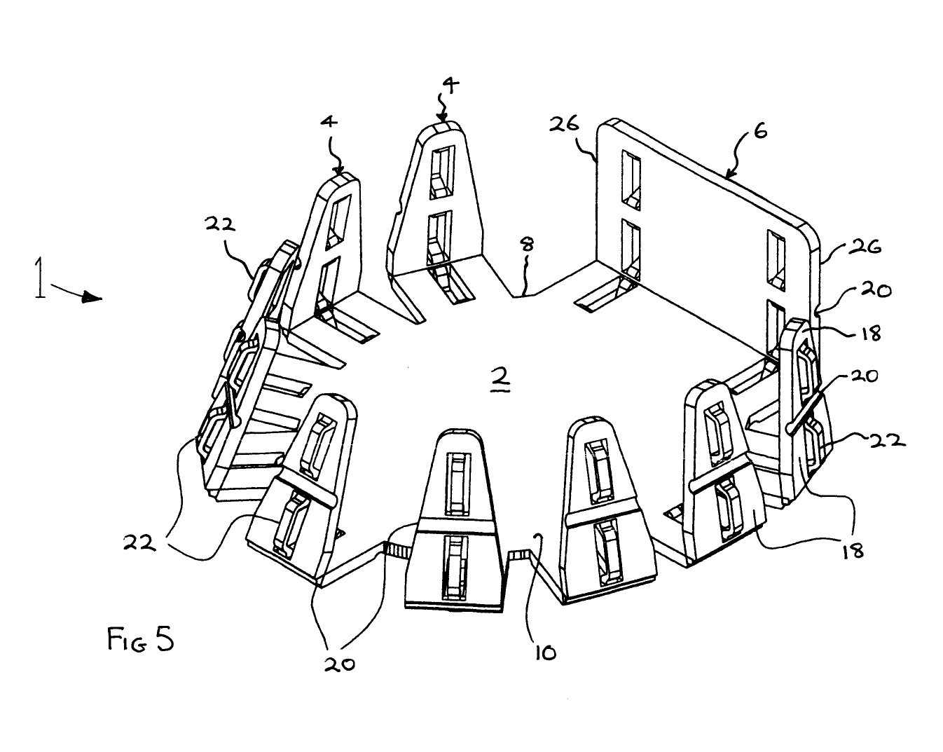

The animal overshoe 1 shown in the drawings is configured to be fitted to a horse's hoof. When fitting the animal overshoe 1 to a horse's hoof, a horseshoe (not shown) that has been used on the animal may be used as a size reference while preparing the overshoe for fitting. The overshoe 1 is offered up to the horseshoe in the generally planar condition shown in FIGS. 2 and 3 and the fingers 4 are then folded at an appropriate hinge 16, 18 to bring them into an upstanding condition as close as possible to the outer periphery of the horseshoe. FIG. 4 illustrates the condition of the overshoe 1 if the folds are made at the first hinges 16, while FIG. 5 illustrates the condition of the overshoe 1 if the folds are made at the radially innermost of the second hinges 20. It will be seen that folding the hinges at the radially innermost hinges 20, as shown in FIG. 5, allows the radially innermost segments 18 of the overshoe to remain in the plane of the base plate 2, thereby effectively increasing the size of the base plate and allowing fitting to a larger hoof. It will also be understood that the size of the shoe can be further increased by making the folds at the radially outermost of the hinges 20. The elongate securing member 24 may then be threaded through the loops defined by the formations 22 on the fingers 4. It will usually be easiest to thread the elongate securing member 24 through the loops defined by the radially outermost formations 22 to assist in maintaining the fingers 4 in an upstanding condition. However, this is not essential. For example, the condition in the condition illustrated in FIG. 5, it may be more convenient to thread the elongate securing member 24 through the loops on the middle segment 18. At this stage, the rear folding portion 6 has not been folded and remains in the plane of the base plate 2 so the overshoe 1 takes on the shape of a slipper that has an open back. When ready the animal's hoof 40 (FIG. 1) is lifted and the “slipper” is slipped onto the front of the hoof. The rear folding portion 6 is then folded up at the same hinge 16, 20 level as the fingers 4. An end of the elongate securing member 24 is then fitted through the loops defined by the formations 22 on the rear folding portion 6. The elongate securing member 24 is then tightened and locked to secure the overshoe 1 to the hoof 40.

When the fingers are pre-shaped prior to fitting to the hoof 40, the overshoe 1 can be fitted to the animal in less than thirty seconds, which causes far less stress to the animal than a lengthier fitting process. If an old horseshoe is not available, or the overshoe 1 is being fitted to an animal other than a horse, the base plate 2 may be temporarily fitted to the animal's foot in order to ascertain the correct size, prior to folding the fingers 4 at the appropriate hinges 16, 20.

It will be understood that if the elongate securing member 24 is not fitted to, or engaged with, the formations 22 on the radially outermost segments 18, those unused segments may be cut off. For example, referring to FIG. 4, if the elongate securing member 24 were engaged with the formations 22 on the middle segments 18, the radially outermost segments 18 may be cut off using the hinges 18 as guides for the cuts.

Referring to FIG. 1, when the animal overshoe 1 is used as a protector after a bandage or poultice (not shown) has been fitted to a diseased or damaged hoof 40, an intermediate sock 42 may be fitted before fitting the overshoe. The intermediate sock 42 may be made of a moisture-proof material, which is also air permeable. The intermediate sock 42 may be provided with a pull cord 44 or the like the adjacent the mouth of the sock to allow it to be secured to the animal's leg 46 prior to fitting the animal overshoe 1. As an alternative to a pull cord 44, the intermediate sock 42 may be provided with one or more elastic members or any other suitable means for securing the sock to an animal's leg. The animal overshoe 1 protects the intermediate sock 42 against undue wear or damage, while a bandage or poultice may be protected from the elements by the intermediate sock 42. Making the intermediate sock 42 from an air permeable material ensures that the ailment, or injury, is able to “breathe” through the intermediate sock.

As shown in FIGS. 2 and 3, the base plate 20 of the animal overshoe 1 may be provided with a plurality of discontinuities, which in the illustrated example are through-holes 50. If a circumstance exists in which a hoofed animal requires support within the hoof cavity, that is the sole up bulging, horn jets and radiation furrows on the bottom surface of the hoof (not shown), a correspondingly shaped filler, or wadding, hereinafter termed a profiled insert 52, can be made by placing a suitable filler material on the top surface 10 of the base plate 2. The filler will readily migrate into the through-holes 50 when the base plate 2 is pressed against the hoof to mold the filler material into the shape of the cavity. When the filler material sets, the filler in the through-holes 50 serves to secure the profiled insert 52 to the base plate 2. The filler may be covered with a thin plastic film or the like (not shown), or the hoof cavity may be coated with petroleum jelly, so that the filler will take up the shape of the hoof cavity, but not stick to the hoof. The overshoe 1 with the shaped filler can then be set aside until such time as the filler has set to form the profiled insert 52 and is ready for use. This allows the simple and inexpensive provision of custom made therapeutic protective footwear for hoofed animals in particular. The filler material may be selected for suitable adhesion and resilience properties and may, for example, be silicon.

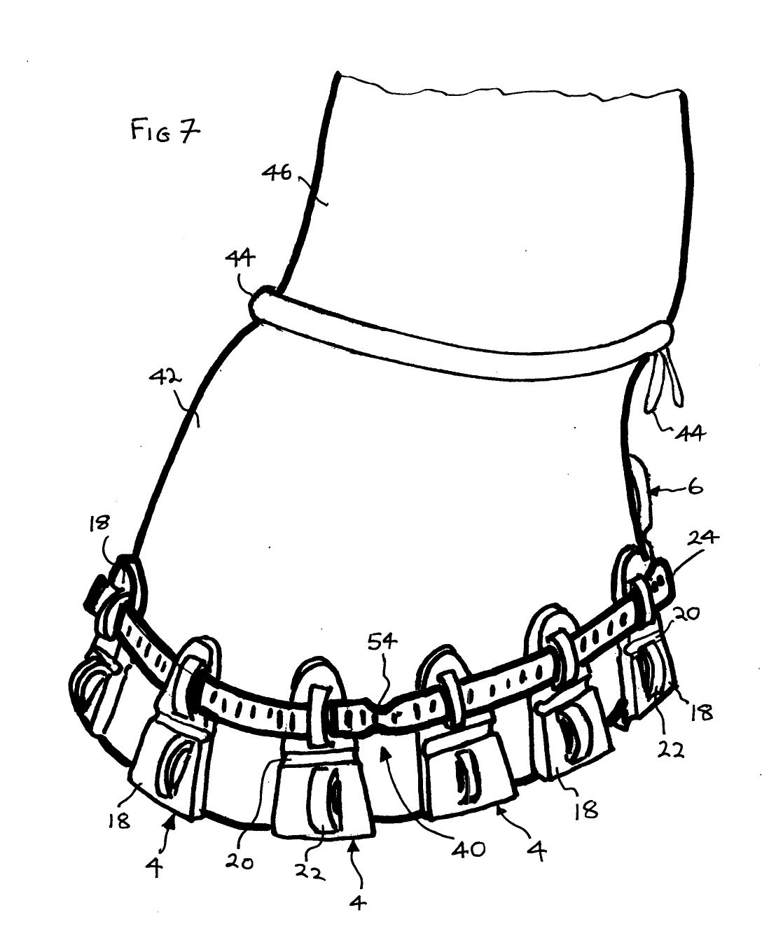

Referring to FIG. 7, as a safety precaution, the elongate securing member 24 may be provided with a weakening formation 54 that reduces the structural strength of the securing member and is designed to break, or snap, to allow quick removal of the overshoe 1. This may be desirable if, for example, the overshoe 1 was to get caught on a foreign object.

In the illustrated example, the first and second hinges 16, 20 take the form of arcuate section grooves defined in the fingers 4 and rear folding portion 6. It will be understood that other forms of hinge may be used and that one or more of the hinges 16, 20 may include a swivel pin that connects separate elements to one another.

In the illustrated example the animal overshoe 1 is a one-piece plastics molding. This is not essential as other constructions may be used. For example, the fingers 4 and rear folding portion 6 may be made of leather or another suitably flexible material and attached to a relatively rigid base plate. In such structures, the flexibility of the material would allow a hinge action at the point of connection with the relatively rigid base plate and the flexibility to enable the overshoe to be applied to a range of different sized feet.

In the illustrated example, the animal overshoe 1 comprises a plurality of relatively narrow fingers 4 and a relatively wider rear folding portion 6. This arrangement is considered suitable for an animal overshoe intended for use on a horse's hoof. However, as an alternative to a rear folding portion as illustrated, one or more additional fingers may be used. This may be desirable when the animal overshoe is intended for an animal with a foot shape that does not suit having a rear folding portion as shown in the illustrated example.

The animal overshoe may be molded from any suitable plastics material that provides a desired degree of wear resistance and flexibility. The animal overshoe may, for example, be made of polyurethane, which has been used in the manufacture of ski boots and shown to be highly resistant to wear while remaining pliable at low winter temperatures.

In the illustrated example the formations provided on the fingers and rear folding portion combine with the finger or rear folding portion to define respective loops through which the elongate securing member can be threaded. It will be understood that other formations may be used. For example, the formations may comprise open hooks or the like. Another alternative would be projections with a bulbous head or reduced section away from the head, over which a flexible strap with suitable sized perforations may be forced. The use of hook-like structures or relatively simple projections, rather than a loop construction, may reduce tooling and production costs.

In some examples, the elongate securing member may be formed in segments having a first end integral with an elongate member 4, 6 and the second end configured to engage a formation provided on an adjacent securing member such that when all of the segments have their second ends connected to the formation provided on an adjacent elongate member a continuous securing band is formed.

Thus, although there have been described particular embodiments of the present invention of a new and useful Animal Overshoes it is not intended that such references be construed as limitations upon the scope of this invention except as set forth in the following claims.

What is claimed is:

1. An animal overshoe comprising:
a base plate; and
a plurality of elongate members connected to said base plate,
wherein said elongate members each comprise a formation configured to enable securing of the overshoe to a foot of an animal by an elongate securing member engaging said formations with at least a portion of each said elongate member in an upstanding condition with respect to said base plate.

2. An overshoe as claimed in claim 1, wherein said elongate members are hinge connected to said base plate by respective first hinges configured to permit movement of the elongate member to an upstanding position in which the elongate member is upstanding with respect to said base plate.

3. An overshoe case claimed in claim 2, wherein said first hinges connect said elongate members to an outer periphery of said base plate, said outer periphery comprises a front end portion having an arched profile and a rear end portion extending transverse to said arched profile and extending between respective ends of said arched profile, there is a plurality of elongate members having a first width connected to said front end portion and one elongate member attached to said rear end portion that has a width greater than said first width and extends between said respective ends.

4. An overshoe as claimed in claim 1, wherein said base plate is at least semi-rigid.

5. An overshoe as claimed in claim 2, wherein each of said elongate members comprises a plurality of segments that are connected to adjacent segments of the elongate member by respective second hinges configured such that the segments can each be moved to an upstanding position with respect to said base plate independently of movement permitted by the respective said first hinges.

6. An overshoe as claimed in claim 5, wherein at least two segments of each elongate member are provided with respective said formations.

7. An overshoe as claimed in claim 5, wherein said second hinges comprise respective grooves defined in said elongate members.

8. An overshoe as claimed in claim 1, wherein said base plate is a generally planar member.

9. An overshoe as claimed in claim 1, wherein the overshoe is a one-piece plastics molding.

10. An overshoe as claimed in claim 9, wherein said molding is a generally planar molding.

11. An overshoe as claimed in claim 1, further comprising a said elongate securing member to engage said formations.

12. An overshoe as claimed in claim 11, wherein said elongate securing member has a first end, a second end and a weakening formation provided intermediate said first and second ends to facilitate breaking of said elongate securing member to release the overshoe from said animal's foot.

13. An overshoe as claimed in claim 1, wherein an underside of said base plate is provided with at least one ground gripping profile.

14. An overshoe as claimed in claim 1, wherein said base plate is provided with a plurality of discontinuities to facilitate gripping by a mouldable material placed on an upper surface of said base plate for molding to the shape of a cavity in the animal's foot.

15. An overshoe as claimed in claim 1, wherein said formations are configured to cooperate with the respective elongate members to define respective closed loops.

16. An animal overshoe comprising:
a base plate; and
a plurality of elongate members hinge connected to an outer periphery of said base plate by respective first hinges to permit movement of said elongate members to an upstanding condition with respect to said base plate,
wherein said elongate members each comprise a plurality of segments that are connected to adjacent segments of the elongate member by respective second hinges to permit each segment to be moved to an upstanding position with respect to said base plate independently of movement permitted by said first hinges,
wherein said elongate members each comprise a formation configured to enable securing of the overshoe to a foot of an animal by an elongate securing member engaging said formations with at least a portion of each said elongate member in said upstanding condition with respect to said base plate, and
wherein said outer periphery comprises a front end portion having an arched profile and a rear end portion extending transverse to said arched profile and extending between respective ends of said arched profile, the elongate members connected to said front end portion have a first width and there is one elongate member attached to said rear end portion that has a width greater than said first width.

17. An animal overshoe as claimed in claim 16, wherein said formations are configured to cooperate with the respective elongate members to define respective closed loops.

18. An animal overshoe as claimed in claim 16, configured for fitting to a hoof of a horse.

19. A method of providing an overshoe on an animal's foot, said method comprising:
applying a base plate of an overshoe to a body representative of the said of the animal's foot and bending a plurality of elongate members that project from an outer periphery of said base plate to bring at least a portion of each said elongate member into an upstanding condition so that said upstanding elongate members partially surround said outer periphery leaving an opening at said outer periphery;
separating said overshoe from said body;
inserting said animal's foot through said opening to position an underside of said foot on said base plate with said upstanding elongate members partially surrounding said foot,
bending further elongate members that project from said outer periphery to bring at least a portion of each of said further elongate members into an upstanding condition to close said opening; and
securing said overshoe to said foot by fitting an elongate securing member to respective formations provided on said elongate members.

20. A method as claimed in claim 19, wherein said formations are configured to cooperate with said elongate members to define respective closed loops and fitting said elongate securing member comprises threading said elongate securing member through said loops.
